(19) United States
(12) Patent Application Publication
(10) Pub. No.: US 2025/0076772 A1
(43) Pub. Date: Mar. 6, 2025

(54) RESIST PATTERN PREDICTION DEVICE AND RESIST PATTERN PREDICTION DEVICE CONSTRUCTION SYSTEM

(71) Applicant: SAMSUNG ELECTRONICS CO., LTD., Suwon-si (KR)

(72) Inventors: Hanveen Koh, Suwon-si (KR); Kyoungyoon Park, Suwon-si (KR); Taehyung Yoo, Suwon-si (KR); Sooyong Lee, Suwon-si (KR)

(21) Appl. No.: 18/665,030

(22) Filed: May 15, 2024

(30) Foreign Application Priority Data
Sep. 5, 2023 (KR) 10-2023-0117364

(51) Int. Cl. G03F 7/00

(52) U.S. Cl. CPC G03F 7/70441; G03F 7/705; G03F 7/70625; G03F 7/70666

(57) ABSTRACT

Disclosed is a resist pattern prediction device, which includes an optical proximity correction module for generating both an optical proximity correction and a non-optical proximity correction. The optical proximity correction module generates an aerial image by performing an optical proximity correction based on a mask image. The module also generates a resist image by performing a non-optical proximity correction on the mask image and the aerial image. The resist pattern prediction device also includes a pattern prediction module that predicts information with respect to a resist pattern based on the resist image. The non-optical proximity correction includes performing a convolution operation on the aerial image using a Volterra kernel based on a coefficient of a quadratic term of a Volterra series.

### CROSS-REFERENCE TO RELATED APPLICATION

This application claims priority under 35 U.S.C. § 119 to Korean Patent Application No. 10-2023-0117364 filed on Sep. 5, 2023, in the Korean Intellectual Property Office, the disclosure of which is incorporated by reference herein in its entirety.

### BACKGROUND

Generally, semiconductor devices are manufactured in the form of integrated circuits by repeatedly forming a patterned film on a wafer and by stacking patterned films of various materials in a multi-layer structure. Accordingly, the so-called photolithography process of forming a resist film of a desired material on a wafer and then patterning the formed film is inevitably involved in the manufacture of semiconductor devices.

### SUMMARY

Implementations of the present disclosure provide a resist pattern prediction device having improved accuracy.

Implementations of the present disclosure provide a method and system for constructing a resist pattern prediction device with improved accuracy.

A resist pattern prediction device includes an optical proximity correction module that generates an aerial image by performing an optical proximity correction based on a mask image and generates a resist image by performing a non-optical proximity correction on the mask image and the aerial image, and a pattern prediction module that predicts information with respect to a resist pattern based on the resist image, and the performing of the non-optical proximity correction includes performing a convolution operation on the aerial image using a Volterra kernel based on a coefficient of a quadratic term of a Volterra series.

A semiconductor layout design system includes a layout design device that generates an initial mask image for fabricating a photomask and a resist pattern prediction device that generates prediction data including information on a resist pattern to be formed on a wafer based on the initial mask image. The layout design device generates a final layout with respect to the initial mask image based on the prediction data. The resist pattern prediction device includes an optical proximity correction module that generates an aerial image by performing an optical proximity correction based on the initial mask image and generates a resist image by performing a non-optical proximity correction on the initial mask image and the aerial image. The resist pattern prediction device also includes a pattern prediction module that predicts information with respect to the resist pattern based on the resist image to generate the prediction data. The non-optical proximity correction includes performing a convolution operation on the aerial image using a Volterra kernel based on a coefficient of a quadratic term of a Volterra series.

A resist pattern prediction device construction system includes a database that stores a sample mask image and gauge data obtained by gauging an actual resist pattern generated using a photomask created based on the sample mask image. The device also includes an optical proximity correction module that generates a sample resist image through a convolution operation using a kernel based on the sample mask image, a pattern prediction module that predicts information with respect to a resist pattern based on the sample resist image to generate prediction data, and an optimization module that updates parameters of the kernel of the optical proximity correction module by performing an optimization operation based on the gauge data and the prediction data. The gauge data includes information associated with gauge edge placement coordinates and gauge critical dimensions, and the prediction data includes information associated with predicted edge placement coordinates and predicted critical dimensions.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an example resist pattern prediction device.

FIG. 2 is a block diagram illustrating an example of an optical proximity correction module of FIG. 1.

FIG. 3 is a diagram illustrating an example of a mask image of FIG. 2.

FIG. 4 is a diagram illustrating an example of an aerial image of FIG. 2.

FIG. 5 is a diagram illustrating an example of a resist image of FIG. 2.

FIG. 6 is a block diagram illustrating an example of a resist model of FIG. 2.

FIG. 7 is a diagram for describing a convolution operation performed by a first convolution unit of FIG. 6.

FIG. 8 is a block diagram illustrating an example of a quenching unit of FIG. 6.

FIG. 9 is a diagram for describing an operation of a truncation unit of FIG. 8.

FIG. 10 is a block diagram illustrating an example of a Volterra operation unit of FIG. 6.

FIG. 11 is a diagram for describing a Volterra kernel.

FIG. 12 is a diagram for describing coordinates of specific kernel data of a Volterra kernel of FIG. 11.

FIG. 13 is a diagram illustrating an example of extracting edge placement coordinates of a resist pattern based on a resist image in a pattern prediction module of FIG. 1.

FIG. 14 is a diagram illustrating another example of extracting edge placement coordinates of a resist pattern based on a resist image in a pattern prediction module of FIG. 1.

FIG. 15 is a diagram for describing a prediction of a pattern shape of a resist pattern based on edge placement coordinates in a pattern prediction module of FIG. 1.

FIG. 16 is a diagram for describing a prediction of a critical dimension based on a pattern shape of a resist pattern in a pattern prediction module of FIG. 1.

FIG. 17 is a block diagram illustrating an example of a semiconductor layout design system.

FIG. 18 is a flowchart illustrating an operation method of a semiconductor layout design system of FIG. 17.

FIG. 19 is a flowchart illustrating an example of a learning method of a resist pattern.

FIG. 20 is a block diagram illustrating an example resist pattern prediction device construction system.

FIG. 21 is a diagram illustrating an example of a sample resist image.

FIG. 22 is a block diagram illustrating an example of an optimization module of FIG. 20.

FIG. 23 is a diagram for describing a unit of an edge placement error calculating module of FIG. 22.

FIG. 24 is a diagram for describing a unit of an edge placement error calculating module of FIG. 22.

### DETAILED DESCRIPTION

As used herein, the terms “device”, “module”, or “unit” refer to any combination of software, firmware, and/or hardware configured to provide the functionality described herein. For example, software may be implemented as a software package, code and/or instruction set or instructions, and hardware, for example, may include hardwired circuitry, programmable circuitry, state machine circuitry, and/or a single or any combination, or assembly of firmware that stores instructions executed by programmable circuitry.

In addition, it should be understood that operations performed in two or more modules or units in this specification may be performed through a single undifferentiated module, unit, device, or system, unlike illustrated.

Hereinafter, implementations of the present disclosure may be described in detail and clearly to such an extent that one of ordinary skill in the art may easily implement the present disclosure.

Implementations of the present disclosure described herein relate to a resist pattern prediction device, and more particularly, relate to a resist pattern prediction device for predicting a resist pattern formed on a wafer after performing a photoresist process based on a mask image, and a resist pattern prediction device construction system for constructing the same. To manufacture microelectronic circuits, features are defined in a photoresist by exposing the resist to masked light and then performing an operation on the underlying wafer. The size of the circuit features are small and thus the masking and illumination procedure may first be precisely modelled and the minimum feature size may be confirmed and the models refined prior to using the photolithography steps in actual production. The present disclosure describes such a process for refining the photolithography process.

The photolithography process involves a series of processes that form, on a wafer, a resist film made of a photosensitive polymer material whose solubility changes when irradiated with light such as X-rays or ultraviolet rays. On the wafer on which a patterning target film such as an insulating film or a conductive film is formed, a resist pattern of the resist film is formed by irradiating light on the resist film through a mask with a predetermined pattern. The resist film is removed in areas where solubility of the resist film in a developer has been increased. The patterning target film exposed by the resist pattern is then etched and the remaining resist pattern is removed through washing.

To form a fine and accurate pattern on a wafer in the photolithography process, the resist pattern should be accurately formed by accurately irradiating light to the desired area of the resist film. Therefore, the shape and critical dimensions of the pattern designed on a photomask should be accurately transferred onto the wafer, and inspection of the manufactured photomask and correction according to the inspection results should be carried out precisely.

The photomasks are manufactured including a simulation using an optical proximity correction (OPC), and the simulation of optical proximity correction is performed first by considering the influence of optical elements, using an optical model, and then by considering the influence of factors of the photo resist using a resist model.

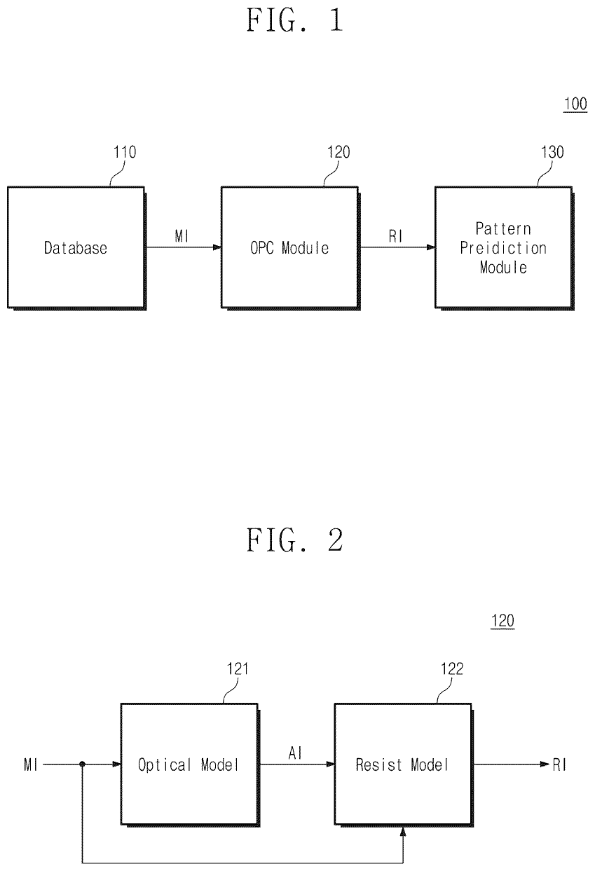

FIG. 1 is a block diagram illustrating a resist pattern prediction device.

Referring to FIG. 1, a resist pattern prediction device 100 may include a database 110, an optical proximity correction module 120, and a pattern prediction module 130.

The database 110 may be configured to store a mask image MI. The mask image MI may be layout image data for fabricating a photomask. For example, the mask image MI may include patterns corresponding to a resist pattern to be manufactured on a wafer.

The database 110 may be configured to provide the mask image MI to the optical proximity correction module 120.

The optical proximity correction module 120 may be configured to generate a resist image RI based on the mask image MI. The optical proximity correction module 120 may be configured to generate an aerial image by performing an optical proximity correction based on the mask image MI, and to generate the resist image RI by performing a non-optical proximity correction based on the mask image MI and the aerial image. In an implementation, the optical proximity correction module 120 may be configured to perform the non-optical proximity correction based on coefficients of a quadratic term of a Volterra series.

The aerial image may represent the intensity distribution of light modified by an optical element when an exposure process is performed using a photomask fabricated based on the mask image MI. For example, the aerial image may include information associated with the intensity distribution of light reaching a photoresist film on the wafer when the photomask is mounted on the exposure equipment and the exposure process is performed on the wafer.

In an implementation, the optical proximity correction may be performed based on the optical elements. In detail, the optical proximity correction may be performed by considering the optical element that may change the intensity and shape of the light reaching the resist film on the wafer due to diffraction, refraction, reflection, etc. of the light passing through the photomask from a light source during the exposure process. For example, the optical element may include numeric aperture, wavelength, type and size of aperture, etc.

When light is incident on the resist film, complex phenomena may occur, such as part of the light being reflected from the surface, another part being absorbed by the resist film, and another part being reflected from the substrate surface and returning to the resist film. Additionally, the degree of reaction of the resist film exposed to light may be different due to the type and characteristics of the resist film and the type and characteristics of the substrate.

For example, in the case of chemical amplification resist, a series of processes occur in succession, such as a photo acid generator (PAG) being decomposed by energy absorbed by the resist to produce acid. The acid may undergo a diffusion process through a post exposure bake (PEB). The acid may react with a protection group to generate an unprotection group and another acid, and the generated acid may react with another protection group. This phenomenon is expressed as amplification, and the unprotection group is ultimately dissolved in the developer to form a resist pattern.

In an implementation, the non-optical proximity correction may be intended to reflect the intensity of light absorbed by the resist film or the degree to which the resist reacted with light (hereinafter referred to as the degree of resist reaction) when the exposure process is performed.

For example, the resist image RI may include prediction information associated with the resist pattern actually formed on the wafer when using a photomask fabricated based on the mask image MI.

The detailed configuration of the optical proximity correction module 120 will be described later with reference to FIG. 2.

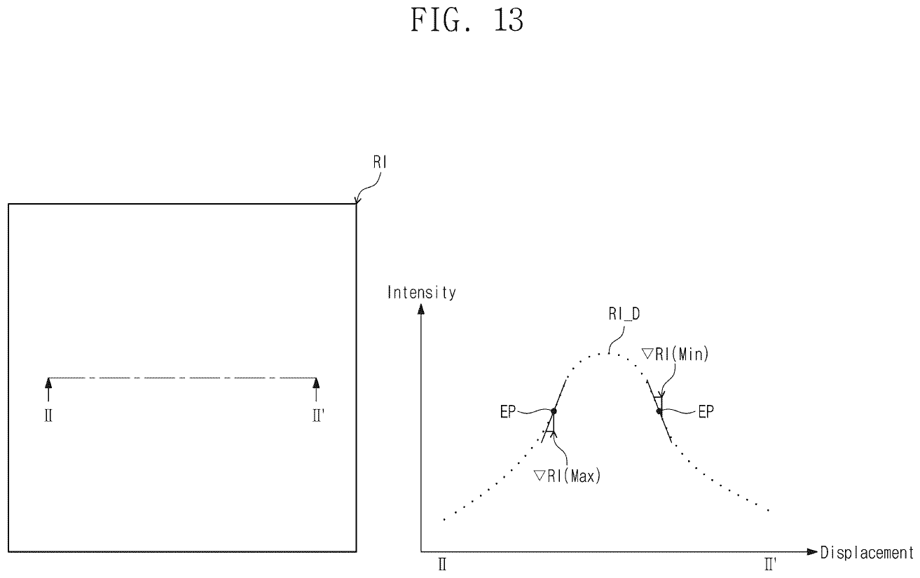

The pattern prediction module 130 may be configured to predict information associated with a resist pattern based on the resist image RI. In an implementation, the pattern prediction module 130 may be configured to predict the pattern shape and critical dimensions of a resist pattern to be formed on the wafer based on the resist image RI. The detailed operation of the pattern prediction module 130 will be described later with reference to FIGS. 13 to 16.

In an implementation according to the present disclosure, a resist image may be generated by performing the non-optical proximity correction based on coefficients of the quadratic term of the Volterra series. Accordingly, the prediction accuracy of the resist pattern prediction device may be improved.

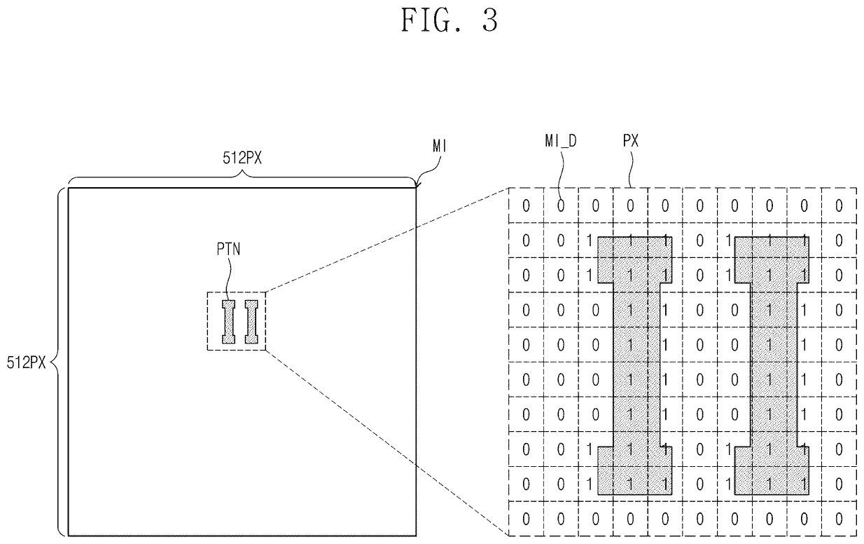

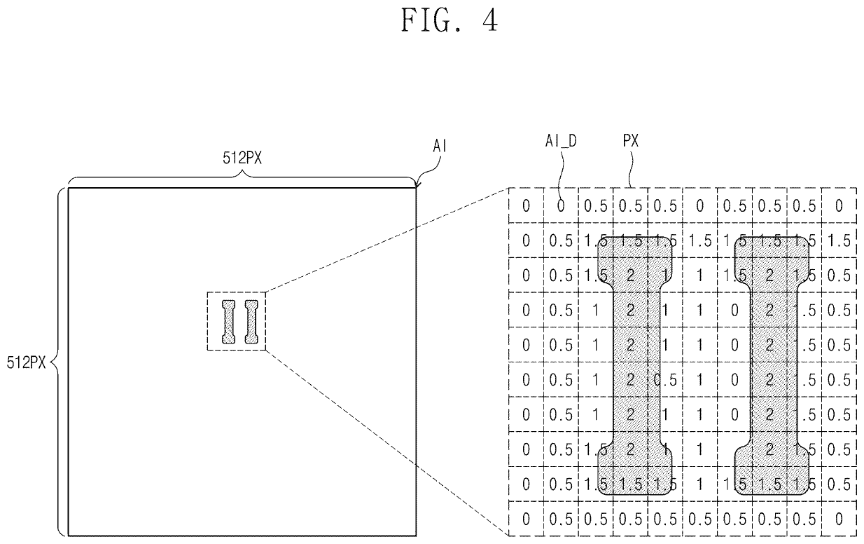

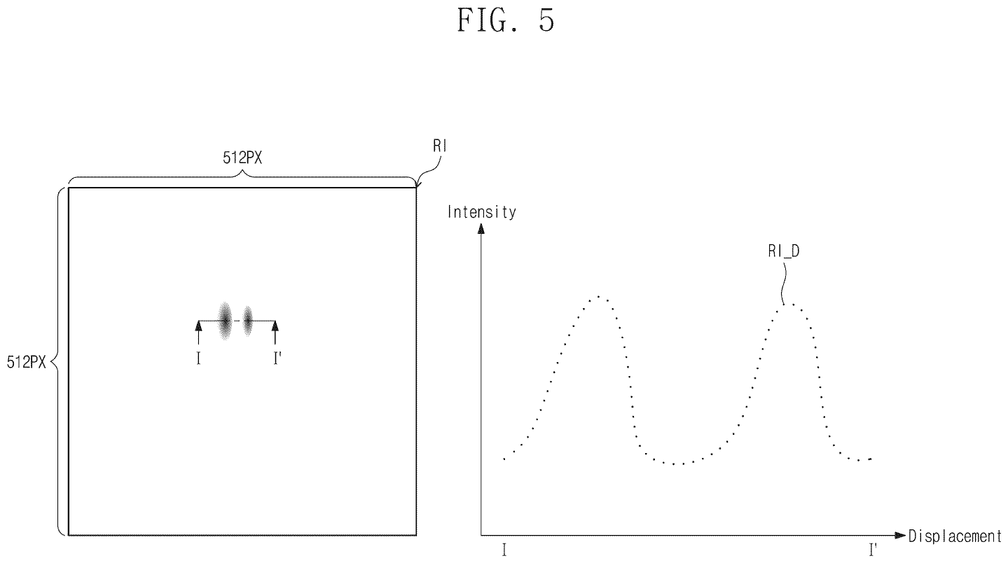

FIG. 2 is a block diagram illustrating an example of the optical proximity correction module of FIG. 1. FIG. 3 is a diagram illustrating an example of the mask image of FIG. 2. FIG. 4 is a diagram illustrating an example of the aerial image of FIG. 2. FIG. 5 is a diagram illustrating an example of the resist image of FIG. 2.

Referring to FIG. 2, the optical proximity correction module 120 may include an optical model 121 and a resist model 122.

The optical model 121 may be configured to generate an aerial image AI by performing the optical proximity correction considering the optical element based on the mask image MI. The aerial image AI generated by the optical model 121 may represent the intensity distribution of light reaching the resist film when an exposure process is performed.

Referring to FIG. 3, the mask image MI may include patterns PTN formed to fabricate a resist pattern on the wafer.

The mask image MI may be provided in an image data format including a plurality of pixels PX. For example, the mask image MI may be image data composed of 512×512 pixels PX, but is not limited thereto.

Mask image data MI_D may be assigned to each pixel PX of the mask image MI. In an implementation, the mask image data MI_D may be assigned to have values of 0 to 1 depending on the extent to which each pixel PX is included in the pattern PTN of the mask image MI.

For example, in the case of the pixel PX that is at least partially included in the pattern PTN of the mask image MI, the mask image data MI_D may be assigned as ‘1’, and in the case of the pixel PX that is not included in the pattern PTN of the mask image MI, the mask image data MI_D may be assigned as ‘0’.

However, the present disclosure is not limited thereto, and unlike what is illustrated, in the case of the pixel PX completely included in the pattern PTN of the mask image MI, the mask image data MI_D may be assigned as ‘1’. In the case of the pixel PX only partially included in the pattern PTN of the mask image MI, the mask image data MI_D may be assigned as ‘0.5’, and in the case of the pixel PX not included in the pattern PTN of the mask image MI, the mask image data MI_D may be assigned to as ‘0’.

Referring to FIG. 4, the aerial image AI, like the mask image MI, may be provided as image data composed of 512×512 pixels PX. Aerial image data AI_D may be assigned to each pixel PX of the aerial image AI. The aerial image data AI_D may refer to the intensity of light reaching a position corresponding to the pixel PX of the resist film when an exposure process is performed.

In an implementation, the aerial image data AI_D may be assigned as values of 0 to 2 depending on the intensity of light reaching the position of the resist film corresponding to each pixel PX of the aerial image AI. For example, the aerial image data AI_D may be assigned as ‘2’ when the intensity of light is very strong, as ‘1.5’ when the intensity of light is strong, as ‘1’ when the intensity of light is normal, as ‘0.5’ when the intensity of light is weak, and as ‘0’ when the intensity of light is very weak.

Referring again to FIG. 2, the resist model 122 may be configured to receive the mask image MI and the aerial image AI. The resist model 122 may be configured to generate the resist image RI by performing the non-optical proximity correction based on the mask image MI and the aerial image AI. For example, the resist model 122 may perform the non-optical proximity correction by applying an acid-quencher mutual diffusion model (AQDM).

The resist image RI generated from the resist model 122 may include prediction information indicating the degree of resist reaction when an exposure process is performed.

Referring to FIG. 5, the resist image RI and a distribution of resist image data RI_D for the plurality of pixels PX along a line I-I′ in the resist image RI may be provided.

The resist image RI, like the mask image MI and the aerial image AI, may be provided as image data composed of 512×512 pixels PX. The resist image data RI_D may be assigned to each pixel PX of the resist image RI. The resist image data RI_D may indicate the degree of resist reaction at a position corresponding to the pixel PX of the resist film when an exposure process is performed.

Hereinafter, the detail configuration and operation of the resist model 122 will be described.

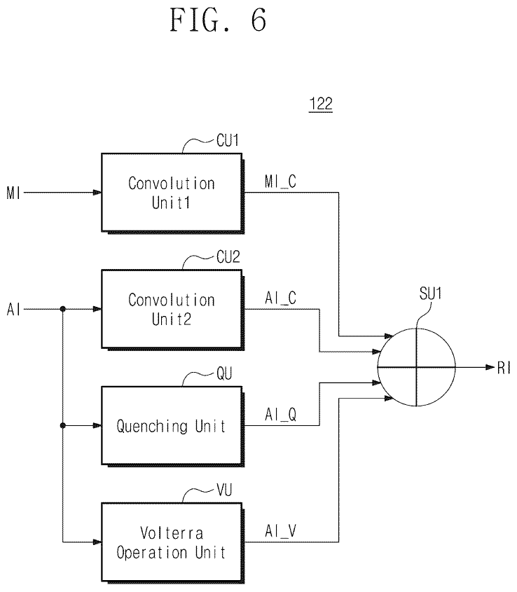

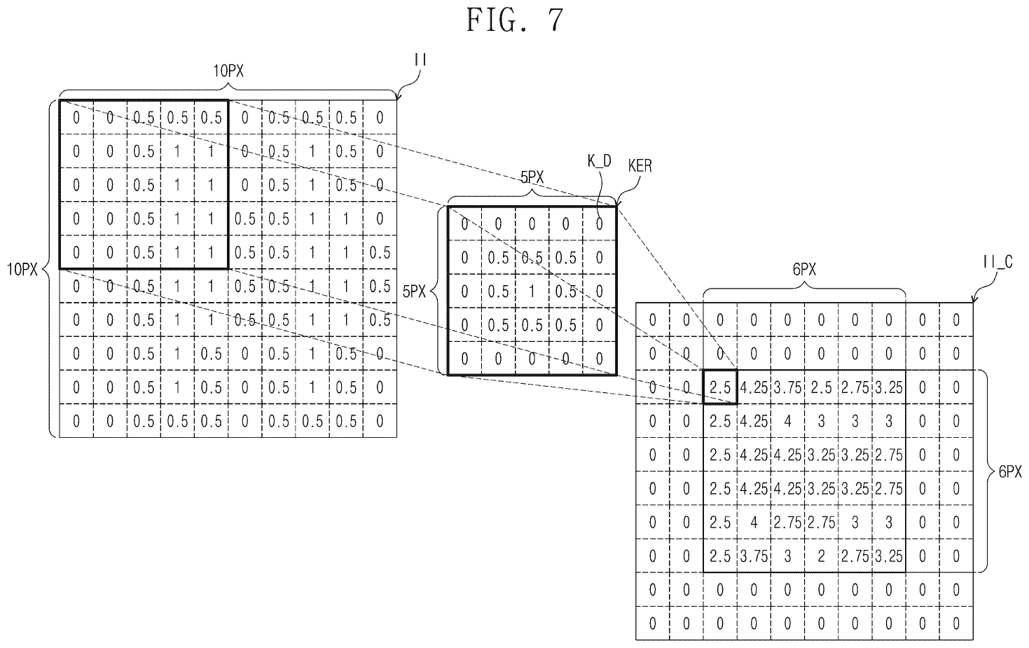

FIG. 6 is a block diagram illustrating an example of a resist model of FIG. 2. FIG. 7 is a diagram for describing a convolution operation performed by a first convolution unit of FIG. 6.

Referring to FIG. 6, the resist model 122 may include a first convolution unit CU1, a second convolution unit CU2, a quenching unit QU, a Volterra operation unit VU, and a first summing unit SU1.

The first convolution unit CU1 may be configured to generate a convolution mask image MI_C by performing a convolution operation as illustrated in Equation 1 below, using a first kernel ker1 with respect to the mask image MI.

$$MI\_C = MI * ker 1 \qquad [ Equation 1 ]$$

In Equation 1, the first kernel ker1 may be a free-form kernel.

In this specification, the free-form kernel may mean that there are no special restrictions on the data constituting the kernel. Accordingly, the user may set the kernel to a Gaussian kernel in which kernel data values follow a Gaussian distribution, or the kernel may be a random kernel in which a kernel data value is arbitrarily set by an optimization algorithm used in a model construction system.

Hereinafter, in this specification, performing a convolution operation using a kernel on an input image will be described as an example of performing a convolution operation using the kernel on an image.

Referring to FIG. 7, a convolution operation may be performed on an input image ‘II’ composed of 10×10 pixels PX using a kernel KER composed of 5×5 pixels PX. In one example, the kernel may be a Gaussian kernel. However, the kernel is not limited to thereto and may be a free-form kernel.

As a result of the convolution, data of 6×6 pixels PX at the center of a convolution input image II_C may be calculated. In an implementation, data of the remaining pixels PX in the outer portion excluding the 6×6 pixels in the center may be assigned as ‘0’.

Referring again to FIG. 6, the second convolution unit CU2 may be configured to generate a convolution aerial image AI_C by performing a convolution operation on the aerial image AI using a second kernel ker2, as illustrated in Equation 2 below.

$$AI\_C = AI * ker 2 \qquad [ Equation 2 ]$$

In Equation 2, the second kernel ker2 may be a free-form kernel.

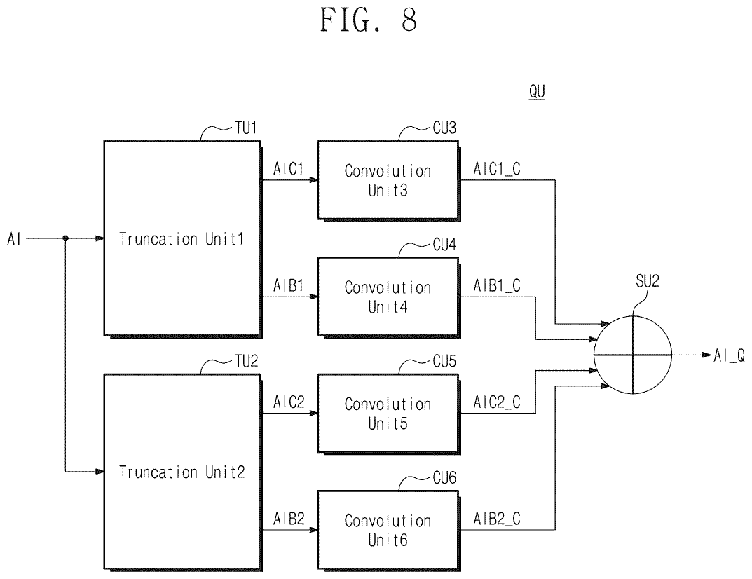

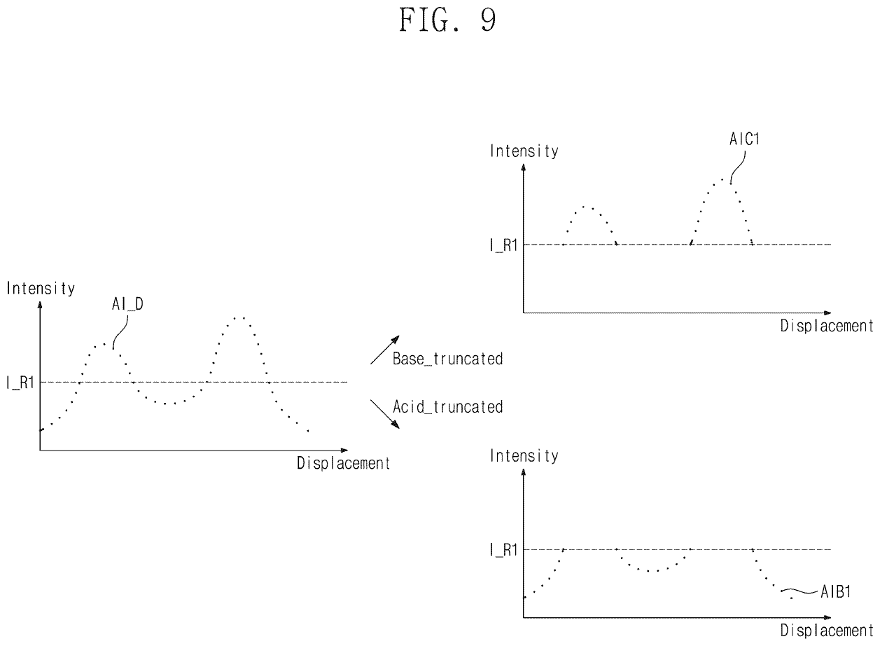

The quenching unit QU may be configured to generate a quenching aerial image AI_Q by performing a quenching operation on the aerial image AI. How the quenching unit QU generates the quenching aerial image AI_Q will be described later with reference to FIGS. 8 and 9.

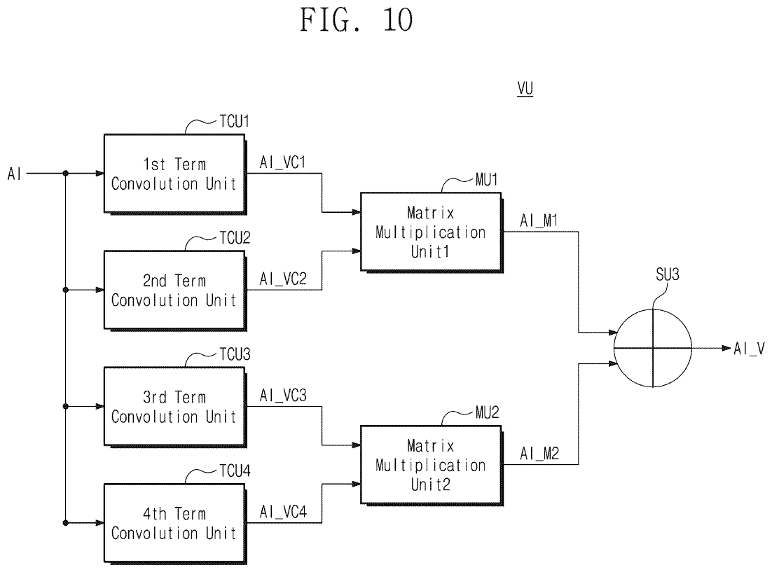

The Volterra operation unit VU may be configured to generate a Volterra aerial image AI_V by performing a Volterra operation on the aerial image AI based on the quadratic term of the Volterra series. How the Volterra operation unit VU generates the Volterra aerial image AI_V will be described later with reference to FIGS. 10 to 12.

The first summing unit SU1 may be configured to generate the resist image RI by summing the convolution mask image MI_C, the convolution aerial image AI_C, the quenching aerial image AI_Q, and the Volterra aerial image AI_V. In an implementation, the first summing unit SU1 may generate the resist image RI by adding all the data allocated to the pixels PX at corresponding positions in the convolution mask image MI_C, the convolution aerial image AI_C, the quenching aerial image AI_Q, and the Volterra aerial image AI_V.

For example, when the data assigned to pixels PX at specific positions in the convolution mask image MI_C, the convolution aerial image AI_C, the quenching aerial image AI_Q, and the Volterra aerial image AI_V are sequentially ‘1’, ‘1.5’, ‘2’, and ‘0.5’, the resist image data RI_D assigned to the pixel PX at the same position in the resist image RI may be 5 (1+1.5+2+0.5=5).

FIG. 8 is a block diagram illustrating an example of a quenching unit of FIG. 6. FIG. 9 is a diagram for describing an operation of a truncation unit of FIG. 8.

Referring to FIG. 8, the quenching unit QU may include a first truncation unit TU1, a second truncation unit TU2, a third convolution unit CU3, a fourth convolution unit CU4, a fifth convolution unit CU5, a sixth convolution unit CU6, and a second summing unit SU2.

The first truncation unit TU1 may be configured to generate a first acid aerial image AIC1 and a first base aerial image AIB1 based on the aerial image AI. In an implementation, the first truncation unit TU1 may perform a base truncation operation based on a first reference value to generate the first acid aerial image AIC1, and may perform an acid truncation operation based on the first reference value to generate the first base aerial image AIB1.

Referring to FIG. 9 together, the first truncation unit TU1 may generate the first acid aerial image AIC1 by leaving only the data that is equal to or greater than a first reference value I_R1 among the aerial image data AI_D assigned to the pixels PX of the aerial image AI and truncating the aerial image data AI_D assigned to the remaining pixels PX, through the base truncation operation. The first truncation unit TU1 may generate the first base aerial image AIB1 by leaving only data less than the first reference value I_R1 among the aerial image data AI_D assigned to the pixels PX of the aerial image AI and by truncating the aerial image data AI_D assigned to the remaining pixels PX, through the acid truncation operation.

In this specification, truncating of data may mean setting all data assigned to the corresponding pixel to ‘0’.

Referring again to FIG. 8, the third convolution unit CU3 may be configured to generate a convolution first acid aerial image AIC1_C by performing a convolution operation on the first acid aerial image AIC1, as illustrated in Equation 3 below, using a third kernel ker3.

$$AIC1\_C = AIC 1 * ker 3 \qquad [ Equation 3 ]$$

In Equation 3, the third kernel ker3 may be a free-form kernel.

The fourth convolution unit CU4 may be configured to generate a convolution first base aerial image AIB1_C by performing a convolution operation on the first base aerial image AIB1, as in Equation 4 below, using a fourth kernel ker4.

$$AIB1\_C = AIB 1 * ker 4 \qquad [ Equation 4 ]$$

In Equation 4, the fourth kernel ker4 may be a free-form kernel.

The second truncation unit TU2 may be configured to generate a second acid aerial image AIC2 and a second base aerial image AIB2 based on the aerial image AI. In an implementation, the second truncation unit TU2 may perform a base truncation operation based on a second reference value to generate the second acid aerial image AIC2 and may perform an acid truncation operation based on the second reference value to generate the second base aerial image AIB2.

The second truncation unit TU2 may generate the second acid aerial image AIC2 by leaving only the data that is equal to or greater than the second reference value among the aerial image data AI_D assigned to the pixels PX of the aerial image AI and truncating the aerial image data AI_D assigned to the remaining pixels PX, through the base truncation operation. The second truncation unit TU2 may generate the second base aerial image AIB2 by leaving only the data that is less than the second reference value among the aerial image data AI_D assigned to the pixels PX of the aerial image AI and truncating the aerial image data AI_D assigned to the remaining pixels PX, through the acid truncation operation.

The fifth convolution unit CU5 may be configured to generate a convolution second acid aerial image AIC2_C by performing a convolution operation on the second acid aerial image AIC2 using a fifth kernel ker5, as illustrated in Equation 5 below.

$$AIC2\_C = AIC 2 * ker 5 \qquad [ Equation 5 ]$$

In Equation 5, the fifth kernel ker5 may be a free-form kernel.

The sixth convolution unit CU6 may be configured to generate a convolution second base aerial image AIB2_C by performing a convolution operation on the second base aerial image AIB2 using a sixth kernel ker6, as in Equation 6 below.

$$AIB2\_C = AIB 2 * ker 6 \qquad [ Equation 6 ]$$

In Equation 6, the sixth kernel ker6 may be a free-form kernel.

The second summing unit SU2 may be configured to sum the convolution first acid aerial image AIC1_C, the convolution first base aerial image AIB1_C, the convolution second acid aerial image AIC2_C, and the convolution second base aerial image AIB2_C to generate the quenching aerial image AI_Q. In an implementation, the second summing unit SU2 may generate the quenching aerial image AI_Q by adding together data assigned to pixels PX at corresponding positions in the convolution first acid aerial image AIC1_C, the convolution first base aerial image AIB1_C, the convolution second acid aerial image AIC2_C, and the convolution second base aerial image AIB2_C.

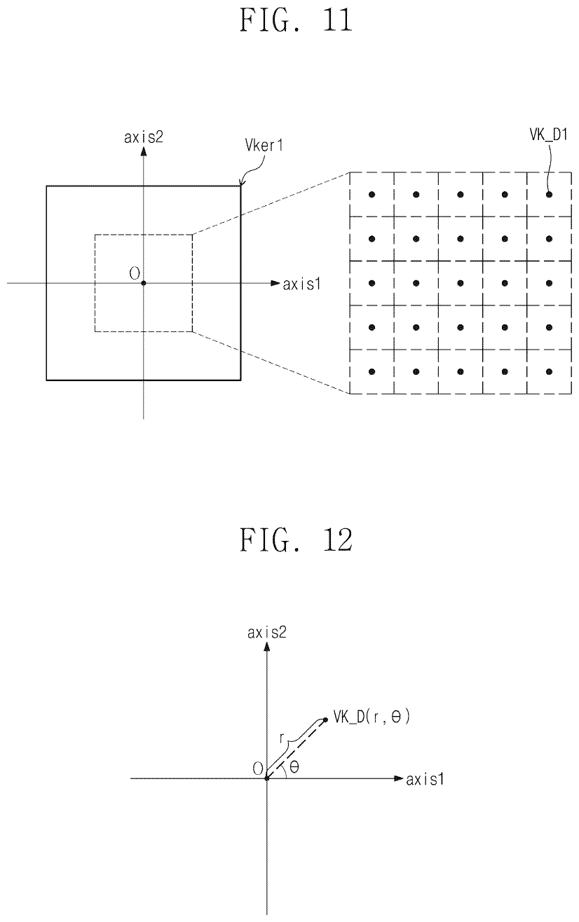

FIG. 10 is a block diagram illustrating an example of a Volterra operation unit of FIG. 6. FIG. 11 is a diagram for describing a Volterra kernel according to the present disclosure. FIG. 12 is a diagram for describing coordinates of specific kernel data of a Volterra kernel of FIG. 11.

Referring to FIG. 10, the Volterra operation unit VU may include a first term convolution unit TCU1, a second term convolution unit TCU2, a third term convolution unit TCU3, a fourth term convolution unit TCU4, a first matrix multiplication unit MU1, a second matrix multiplication unit MU2, and a third summing unit SU3.

The first term convolution unit TCU1 may be configured to generate a first Volterra convolution aerial image AI_VC1 using a first Volterra kernel Vker1 with respect to the aerial image AI, as illustrated in Equation 7 below.

$$AI\_VT1 = AI * Vker 1 \qquad [ Equation 7 ]$$

In Equation 7, the kernel data of the first Volterra kernel Vker1 may be set based on coefficients of the second term of the Volterra series defined in polar coordinates.

Hereinafter, the first Volterra kernel Vker1 will be described in detail with reference to FIGS. 11 and 12.

Referring to FIGS. 11 and 12, the first Volterra kernel Vker1 may include a plurality of first Volterra kernel data VK_D1. Each of the first Volterra kernel data VK_D1 may be defined on a coordinate plane defined by a first axis axis1 and a second axis axis2. The point where the first axis axis1 and the second axis axis2 intersect may be defined as an origin ‘O’.

Each of the first Volterra kernel data VK_D1 may be set as in Equation 8 below.

$$VK\_D1 = {σ}_{n} ( r ) cos n θ \qquad [ Equation 8 ]$$

In Equation 8, ‘r’ refers to a distance that the coordinates of the first Volterra kernel data VK_D1 are away from the origin ‘O’, and θ refers to an angle counterclockwise from the first axis axis1 (refer to FIG. 12). σₙ(r) means the first coefficient of the quadratic term of the Volterra series with distance ‘r’ as a variable, and ‘n’ may be an integer of 1 or more.

In Equation 8, σₙ(r) cos nθ may refer to data of each element in a matrix obtained by multiplying a matrix (e.g., a square matrix with the same size as the kernel) in which data of each element is expressed as a function σₙ(r) of ‘r’ and a matrix (e.g., a square matrix with the same size as the kernel) in which data of each element is expressed as a function cos nθ of θ.

The second term convolution unit TCU2 may be configured to generate a second Volterra convolution aerial image AI_VC2 using a second Volterra kernel Vker2 with respect to the aerial image AI, as illustrated in Equation 9 below.

$$AI\_VT2 = AI * Vker 2 \qquad [ Equation 9 ]$$

In Equation 9, the kernel data of the second Volterra kernel Vker2 may be set based on coefficients of the second term of the Volterra series defined in polar coordinates.

The second Volterra kernel Vker2 may include a plurality of second Volterra kernel data. Each of the second Volterra kernel data, like the first Volterra kernel data VK_D1, may be defined on a coordinate plane defined by the first axis axis1 and the second axis axis2, and may be set as in Equation 10 below.

$$VK\_D2 = {τ}_{n} ( r ) cos n θ \qquad [ Equation 10 ]$$

In Equation 10, ‘r’ refers to a distance that the coordinates of the second Volterra kernel data are away from the origin ‘O’, and θ refers to an angle counterclockwise from the first axis axis1. τₙ(r) means the second coefficient of the quadratic term of the Volterra series with distance ‘r’ as a variable, and ‘n’ may be an integer of 1 or more.

In Equation 10, τₙ(r)cos nθ may refer to data of each element in a matrix obtained by multiplying a matrix (e.g., a square matrix with the same size as the kernel) in which data of each element is expressed as a function τₙ(r) of ‘r’ and a matrix (e.g., a square matrix with the same size as the kernel) in which data of each element is expressed as a function cos nθ of θ.

The third term convolution unit TCU3 may be configured to generate a third Volterra convolution aerial image AI_VC3 using a third Volterra kernel Vker3 with respect to the aerial image AI, as illustrated in Equation 11 below.

$$AI\_VT3 = AI * Vker 3 \qquad [ Equation 11 ]$$

In Equation 11, the kernel data of the third Volterra kernel Vker3 may be set based on coefficients of the second term of the Volterra series defined in polar coordinates.

The third Volterra kernel Vker3 may include a plurality of third Volterra kernel data. Each of the third Volterra kernel data, like the first Volterra kernel data VK_D1, may be defined on a coordinate plane defined by the first axis axis1 and the second axis axis2, and may be set as in Equation 12 below.

$$VK\_D3 = {σ}_{n} ( r ) sin n θ \qquad [ Equation 12 ]$$

In Equation 12, ‘r’ refers to a distance that the coordinates of the third Volterra kernel data are away from the origin ‘O’, and θ refers to an angle counterclockwise from the first axis axis1. σₙ(r) means the first coefficient of the quadratic term of the Volterra series with the distance ‘r’ as a variable, and ‘n’ may be an integer of 1 or more.

In Equation 12, σₙ(r) sin nθ may refer to data of each element in a matrix obtained by multiplying a matrix (e.g., a square matrix with the same size as the kernel) in which data of each element is expressed as a function σₙ(r) of ‘r’ and a matrix (e.g., a square matrix with the same size as the kernel) in which data of each element is expressed as a function sin nθ of θ.

The fourth term convolution unit TCU4 may be configured to generate a fourth Volterra convolution aerial image AI_VC4 using a fourth Volterra kernel Vker4 with respect to the aerial image AI, as illustrated in Equation 13 below.

$$AI\_VT4 = AI * Vker 4 \qquad [ Equation 13 ]$$

In Equation 13, the kernel data of the fourth Volterra kernel may be set based on the coefficient of the quadratic term of the Volterra series defined in polar coordinates.

The fourth Volterra kernel Vker4 may include a plurality of fourth Volterra kernel data. Each of the fourth Volterra kernel data, like the first Volterra kernel data VK_D1, may be defined on a coordinate plane defined by the first axis axis1 and the second axis axis2, and may be set as in Equation 14 below.

$$VK\_D4 = {τ}_{n} ( r ) sin n θ \qquad [ Equation 14 ]$$

In Equation 14, ‘r’ refers to a distance that the coordinates of the fourth Volterra kernel data are away from the origin ‘O’, and θ refers to an angle counterclockwise from the first axis axis1. τₙ(r) means the second coefficient of the quadratic term of the Volterra series with the distance ‘r’ as a variable, and ‘n’ may be an integer of 1 or more.

In Equation 14, τₙ(r) sin nθ may refer to data of each element in a matrix obtained by multiplying a matrix (e.g., a square matrix with the same size as the kernel) in which data of each element is expressed as a function τₙ(r) of ‘r’ and a matrix (e.g., a square matrix with the same size as the kernel) in which data of each element is expressed as a function sin nθ of θ.

The first matrix multiplication unit MU1 may be configured to generate a first multiplication aerial image AI_M1 by performing a matrix multiplication operation on the first Volterra convolution aerial image AI_VC1 and the second Volterra convolution aerial image AI_VC2. For example, the first matrix multiplication unit MU1 may be configured to generate the first multiplication aerial image AI_M1 by performing a matrix multiplication operation, as illustrated in Equation 15 below.

$$AI\_M1 = [ AI * {σ}_{n} ( r ) cos n θ ] \times [ AI * {τ}_{n} ( r ) cos n θ ] \qquad [ Equation 15 ]$$

The second matrix multiplication unit MU2 may be configured to generate a second multiplication aerial image AI_M2 by performing a matrix multiplication operation on the third Volterra convolution aerial image AI_VC3 and the fourth Volterra convolution aerial image AI_VC4. For example, the second matrix multiplication unit MU2 may be configured to generate the second multiplication aerial image AI_M2 by performing a matrix multiplication operation, as illustrated in Equation 16 below.

$$AI\_M2 = [ AI * {σ}_{n} ( r ) sin n θ ] \times [ AI * {τ}_{n} ( r ) sin n θ ] \qquad [ Equation 16 ]$$

The third summing unit SU3 may be configured to generate the Volterra aerial image AI_V by adding the first multiplication aerial image AI_M1 and the second multiplication aerial image AI_M2. In an implementation, the third summing unit SU3 may generate the Volterra aerial image AI_V by adding all the data allocated to pixels PX at corresponding positions in the first multiplication aerial image AI_M1 and the second multiplication aerial image AI_M2, as in Equation 17 below.

$$AI\_V = [ AI * {σ}_{n} ( r ) cos n θ ] \times [ AI * {τ}_{n} ( r ) cos n θ ] + [ AI * {σ}_{n} ( r ) sin n θ ] \times [ AI * {τ}_{n} ( r ) sin n θ ] \qquad [ Equation 17 ]$$

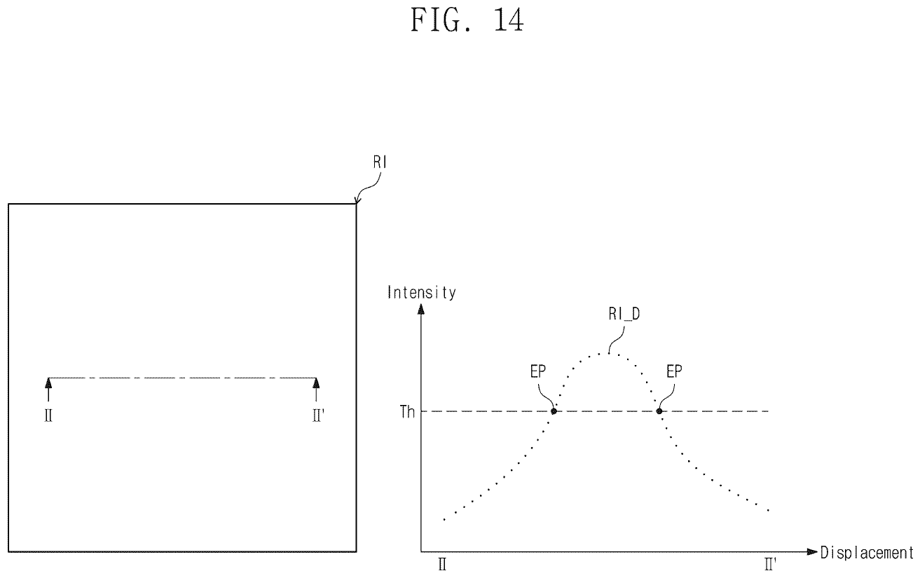

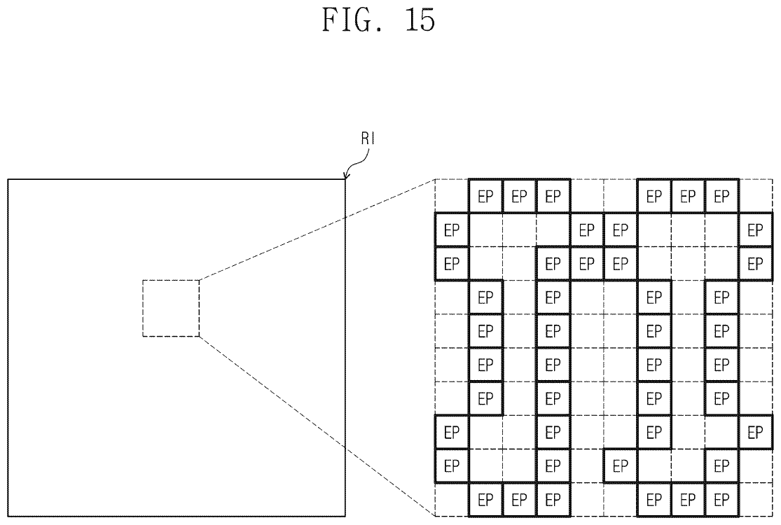

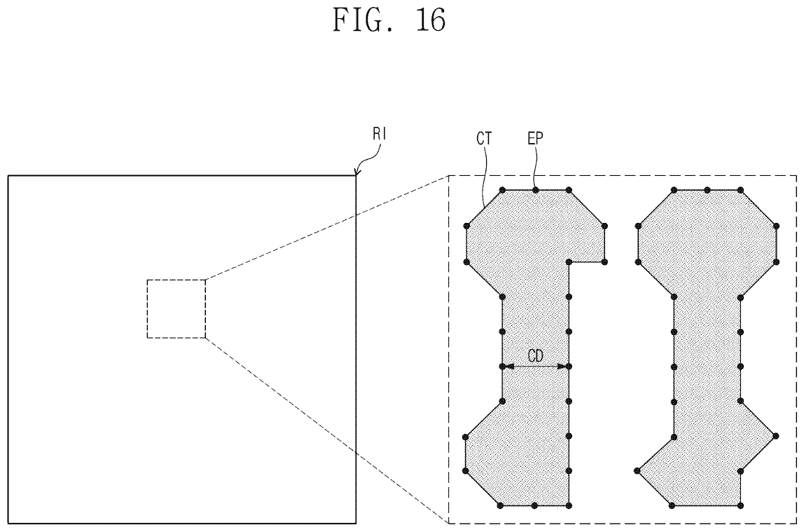

FIG. 13 is a diagram illustrating an example of extracting edge placement coordinates of a resist pattern based on a resist image in a pattern prediction module of FIG. 1. FIG. 14 is a diagram illustrating another example of extracting edge placement coordinates of a resist pattern based on a resist image in a pattern prediction module of FIG. 1. FIG. 15 is a diagram for describing a prediction of a pattern shape of a resist pattern based on edge placement coordinates in a pattern prediction module of FIG. 1. FIG. 16 is a diagram for describing a prediction of a critical dimension based on a pattern shape of a resist pattern in a pattern prediction module of FIG. 1.

Referring to FIGS. 13 and 14, an example of the resist image RI and the distribution of the resist image data RI_D along line II-II′ in the resist image RI is provided. For example, the resist image RI may be provided as image data composed of the plurality of pixels PX, and the resist image data RI_D may be assigned to each pixel PX.

Referring to FIG. 13, in an implementation, the pattern prediction module 130 may extract edge placement coordinates EP based on the amount of change (e.g., a gradient or a slope) in the resist image data RI_D. For example, in the distribution of the resist image data RI_D in a first direction (e.g., the direction parallel to the line II-II′) of the resist image RI, the pattern prediction module 130 may extract coordinates of the pixel PX at a position where the resist image data RI_D increases most steeply (e.g., maximum slope) and coordinates of the pixel PX at a position where the resist image data RI_D decreases most steeply (e.g., minimum slope) as the edge placement coordinates EP, respectively.

Referring to FIG. 14, in another implementation, the pattern prediction module 130 may extract the edge placement coordinates EP by comparing the resist image data RI_D and a threshold value Th. For example, the pattern prediction module 130 may extract coordinates of the pixel PX for which the resist image data RI_D is the threshold value Th as the edge placement coordinates EP.

Referring to FIGS. 15 and 16, the pattern prediction module 130 may be configured to generate prediction data with respect to a resist pattern based on the edge placement coordinates EP.

In an implementation, the pattern prediction module 130 may predict the pattern shape by connecting the edge placement coordinates EP which are adjacent each other and extracting a contour CT of the resist pattern.

In an implementation, the pattern prediction module 130 may be configured to predict a critical dimension CD based on the pattern shape. For example, the pattern prediction module 130 may be configured to calculate the minimum value of the pattern width along the first direction as the critical dimension.

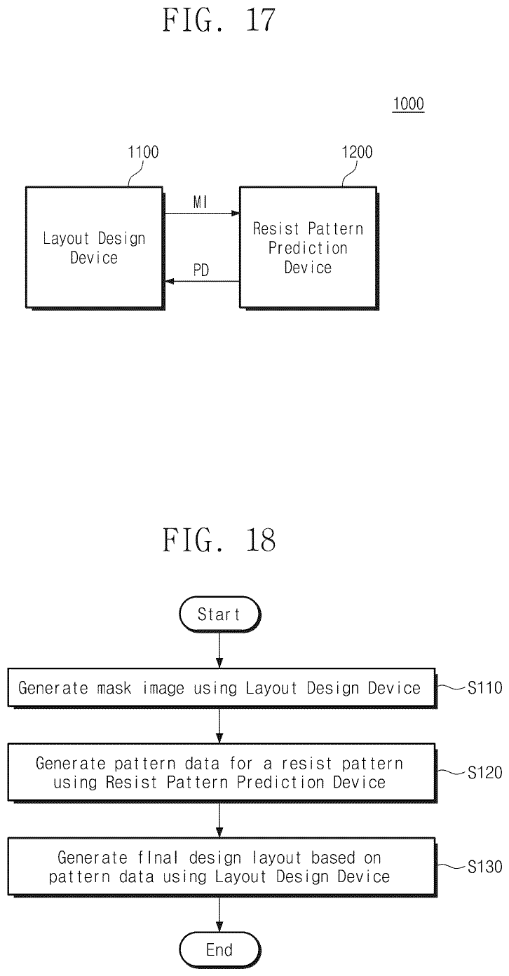

FIG. 17 is a block diagram illustrating an example of a semiconductor layout design system. FIG. 18 is a flowchart illustrating an operation method of the semiconductor layout design system of FIG. 17.

Referring to FIG. 17, a semiconductor layout design system 1000 may include a layout design device 1100 and a resist pattern prediction device 1200. The resist pattern prediction device 1200 may be actually the same as the resist pattern prediction device 100 described with reference to FIGS. 1 to 16.

Referring to FIG. 18 together, in operation S110, the layout design device 1100 may generate the initial mask image MI and provide the generated initial mask image MI to the resist pattern prediction device 1200. The initial mask image MI is layout image data for fabricating a photomask and may be actually the same as the mask image MI of FIG. 1.

In operation S120, the resist pattern prediction device 1200 may be configured to generate prediction data PD by extracting information associated with the resist pattern based on the initial mask image MI. The prediction data PD may include prediction information associated with the pattern shape and the critical dimension of the resist pattern to be formed on the wafer.

In operation S130, the layout design device 1100 may be configured to generate the final layout by performing the optical proximity correction on the initial mask image MI based on the prediction data PD received from the resist pattern prediction device 1200. In an implementation, the layout design device 1100 may be configured to set a target resist pattern and compare the set target resist pattern with the prediction data PD generated by the resist pattern prediction device 1200 to generate the final layout.

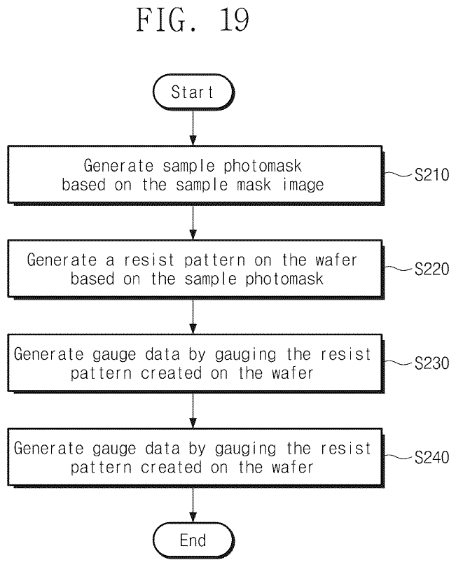

FIG. 19 is a flowchart illustrating an example of a learning method of a resist pattern prediction device according to the present disclosure.

Referring to FIG. 19, in operation S210, a sample photomask may be fabricated based on a sample mask image using a photomask fabrication device. The sample photomask may include patterns corresponding to the resist pattern to be formed on a wafer.

In operation S220, a resist pattern may be generated on the wafer using a photolithography device and the sample photomask. The resist pattern may be generated by performing a photolithography process on the wafer. For example, after forming a resist film on a wafer and exposing the resist film using an exposure equipment mounted with a sample photomask, resist components excluding the resist pattern created after the chemical reaction of the resist film may be removed using a cleaning equipment.

In operation S230, gauge data may be obtained by gauging the resist pattern created on the wafer using a gauge equipment. For example, the gauge equipment may include a scanning electron microscope (SEM). For example, the gauge data may include edge placement coordinates, contours, pattern shapes, and critical dimensions of the resist pattern.

In operation S240, the resist pattern prediction device 1200 may be constructed based on the sample mask image and the gauge data. For example, a resist pattern prediction device construction system may be used to train the sample mask image and the gauge data to an optical proximity correction module.

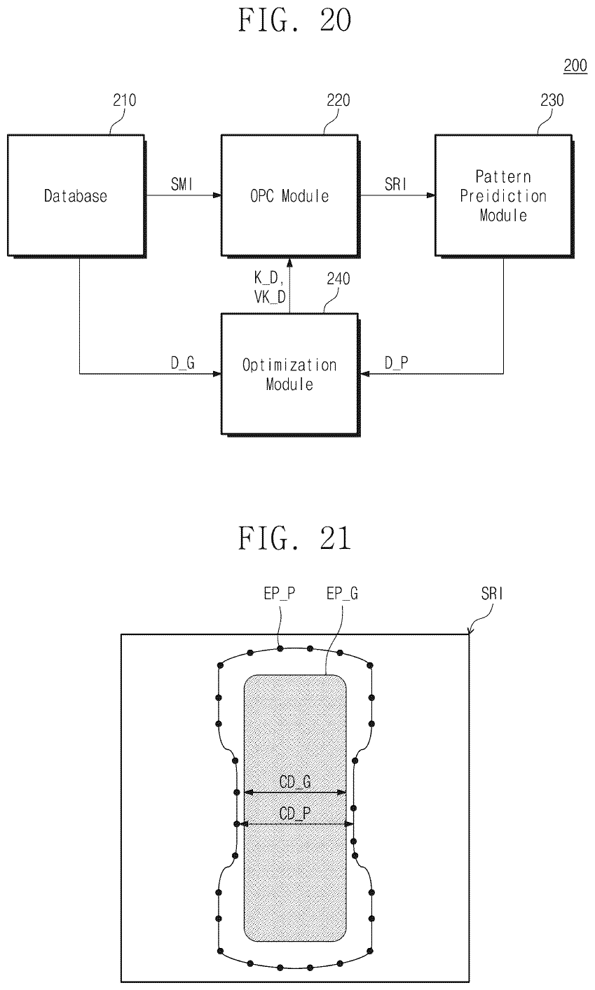

Hereinafter, with reference to FIGS. 20 to 24, the configuration and operation of the resist pattern prediction device construction system will be described in detail.

FIG. 20 is a block diagram illustrating an example resist pattern prediction device construction system.

Referring to FIG. 20, a resist pattern prediction device construction system 200 may include a database 210, an optical proximity correction module 220, a pattern prediction module 230, and an optimization module 240.

The database 210 may be configured to store a sample mask image SMI and gauge data D_G. The sample mask image SMI may correspond to the sample mask image of FIG. 19, and the gauge data D_G may correspond to the gauge data of FIG. 19. For example, the gauge data D_G may include the gauge data D_G obtained by gauging an actual resist pattern created by using a photomask fabricated based on the sample mask image SMI. For example, the gauge data D_G may include information associated with gauge edge placement coordinates and gauge critical dimensions.

The database 210 may be configured to provide the sample mask image SMI to the optical proximity correction module 220.

The optical proximity correction module 220 may be configured to generate a sample resist image SRI based on the sample mask image SMI. The optical proximity correction module 220 may be actually the same as the optical proximity correction module 120 of FIG. 1. In detail, in the same manner as described with reference to FIGS. 1 to 12, the optical proximity correction module 220 may perform the optical proximity correction and the non-optical proximity correction based on the sample mask image SMI to generate the sample resist image SRI.

The pattern prediction module 230 may be configured to generate prediction data D_P by predicting information associated with the resist pattern based on the sample resist image SRI. For example, the pattern prediction module 230 may be configured to generate the prediction data D_P including the prediction information associated with the resist pattern based on the sample resist image SRI. For example, the prediction data D_P may include information associated with the prediction of the edge placement coordinates and the prediction of the critical dimensions. The method by which the pattern prediction module 230 generates the predicted edge placement coordinates and the predicted critical dimensions may be actually the same as that described above with reference to FIGS. 13 to 16.

The optimization module 240 may receive the gauge data D_G from the database 210 and may receive the prediction data D_P from the pattern prediction module 230. The optimization module 240 may be configured to update various parameters of the optical proximity correction module 220 by performing optimization operations based on the gauge data D_G and the prediction data D_P. In an implementation, the optimization module 240 may be configured to update kernel data of various kernels and Volterra kernel data used in convolution operations in the optical proximity correction module.

Hereinafter, the detailed configuration and operation of the optimization module 240 will be described with reference to FIGS. 21 to 24.

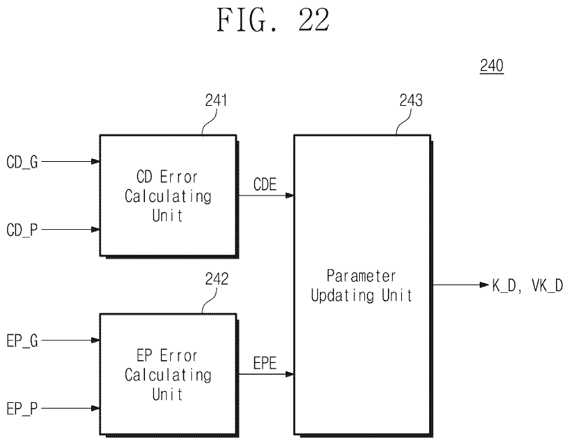

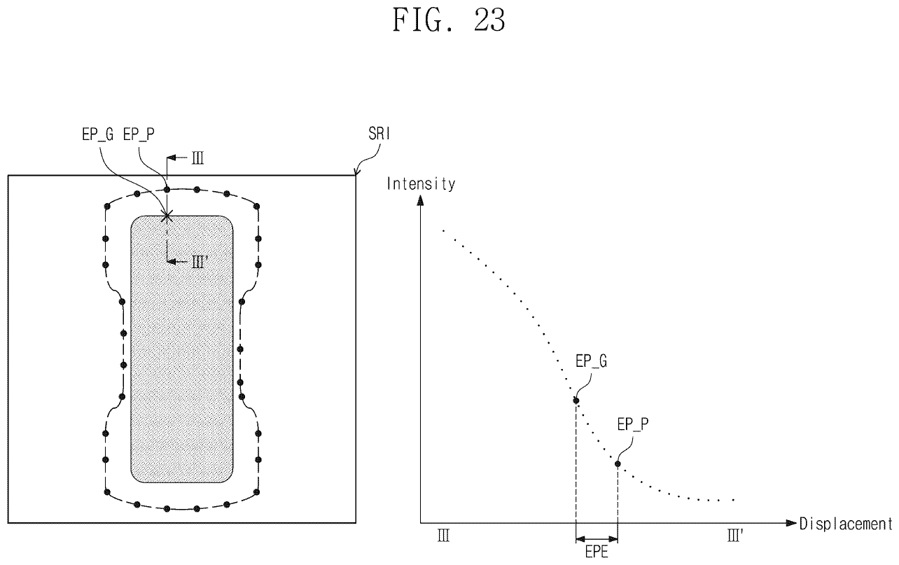

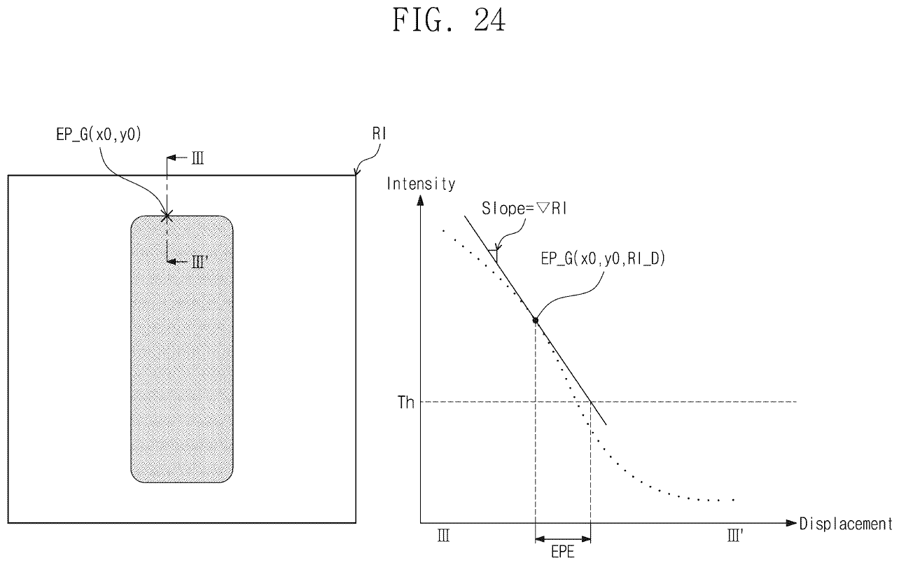

FIG. 21 is a diagram illustrating an example of a sample resist image. FIG. 22 is a block diagram illustrating an example of an optimization module of FIG. 20. FIG. 23 is a diagram for describing a unit of an edge placement error calculating module of FIG. 22. FIG. 24 is a diagram for describing a unit of an edge placement error calculating module of FIG. 22.

Referring first to FIG. 21, the prediction data D_P generated in the pattern prediction module 230 based on the gauge data D_G and sample resist image SRI is provided. The gauge data D_G may include gauge edge placement coordinates EP_G and gauge critical dimensions CD_G, and the prediction data D_P may include predicted edge placement coordinates EP_P and predicted critical dimensions CD_P.

Referring to FIG. 22, the optimization module 240 may include a critical dimension error calculating unit 241, an edge placement error calculating unit 242, and a parameter updating unit 243.

The critical dimension error calculating unit 241 may be configured to calculate a critical dimension error CDE based on the predicted critical dimensions CD_P and the gauge critical dimensions CD_G. In an implementation, the critical dimension error calculating unit 241 may be configured to calculate the critical dimension error CDE based on a difference between the gauge critical dimensions CD_G and the predicted critical dimensions CD_P. In an implementation, when there are a plurality of gauge critical dimensions CD_G and a plurality of predicted critical dimensions CD_P with respect to a plurality of resist patterns, the critical dimension error calculating unit 241 may calculate a root mean square (RMS) of difference values between the gauge critical dimension CD_G and the predicted critical dimension CD_P corresponding to each resist pattern as the critical dimension error CDE.

The edge placement error calculating unit 242 may be configured to calculate an edge placement error EPE based on the predicted edge placement coordinates EP_P and the gauge edge placement coordinates EP_G.

Referring to FIG. 23, in an implementation, the edge placement error calculating unit 242 may be configured to calculate the edge placement error EPE based on a distance between the predicted edge placement coordinates EP_P and the gauge edge placement coordinates EP_G. For example, the edge placement error calculating unit 242 may calculate distances between the nearest gauge edge placement coordinates EP_G for each of the plurality of predicted edge placement coordinates EP_P, and may calculate the root mean square of the calculated distances as the edge placement error EPE.

Referring to FIG. 24, in an implementation, the edge placement error calculating unit 242 may be configured to calculate the edge placement error EPE based on the resist image data RI_D and the gauge edge placement coordinates EP_G.

The edge placement error calculating unit 242 may calculate the edge placement error EPE based on the resist image data RI_D, the threshold value Th, and the gradient corresponding to each of the gauge edge placement coordinates EP_G, as illustrated in Equation 18 below.

$$EPE = \frac{RI\_D ( x 0 , y 0 )}{‖ ∇ RI ‖} \qquad [ Equation 18 ]$$

In Equation 18, ‘Th’ means the threshold value Th and may correspond to the threshold value Th in FIG. 14. ∇RI means a gradient at the gauge edge placement coordinates EP_G (x0, y0).

In Equation 18, RI_D (x0, y0) means a value of the resist image data RI_D at the gauge edge placement coordinates EP_G (x0, y0), and may be calculated as in Equation 19 below.

$$RI\_D ( xo , y 0 ) = {\sum }_{i = - m + 1}^{m} {\sum }_{j = - m + 1}^{m} f ( y 0 - i P ) f ( x 0 - jP ) RI\_D [ i , j ] \qquad [ Equation 19 ]$$

In Equation 19, RI_D[i,j] means a data value at a coordinate (i,j) of the sample register image, ‘m’ is an arbitrary integer, and ‘P’ may be an arbitrary integer. The f(x) may be set to one of the differentiable functions. For example, the f(x) may be a sinc function as in Equation 20 below.

$$f ( x ) = sin c ( \frac{x}{P} ) ( 0.42 + 0.5 cos \frac{π x}{m P} + 0.08 cos \frac{2 π x}{m P} ) \qquad [ Equation 20 ]$$

The edge placement error calculating unit 242 may calculate the root mean square of the edge placement error values calculated based on each of the gauge edge placement coordinates EP_G as the edge placement error EPE.

Referring again to FIG. 22, the parameter updating unit 243 may be configured to update parameters of various kernels such that the critical dimension error CDE and the edge placement error EPE are within a specific standard. For example, the parameter updating unit 243 may be configured to update the parameters using an optimization algorithm of convolutional neural networks (CNN) by setting the critical dimension error CDE and the edge placement error EPE as loss functions. For example, the optimization algorithms may include algorithms such as gradient descent, Adam (adaptive moment estimation), etc.

In implementations according to the present disclosure, the resist pattern construction system may be configured to construct a resist pattern based on gauge critical dimensions and gauge edge placement coordinates. Accordingly, in the case of the present disclosure, prediction accuracy for the critical dimension and pattern shape of the resist pattern fabricated on the wafer may be improved.

An exemplary resist pattern prediction device having improved accuracy is provided in the present disclosure.

A method and system for constructing a resist pattern prediction device with improved accuracy are provided in the present disclosure.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above descriptions are specific implementations for carrying out the present disclosure. Implementations in which a design is changed simply or which are easily changed may be included in the present disclosure as well as an implementation described above. In addition, technologies that are easily changed and implemented by using the above implementations may be included in the present disclosure. Therefore, the scope of the present disclosure should not be limited to the above-described implementations and should be defined by not only the claims to be described later, but also those equivalent to the claims of the present disclosure.

What is claimed is:

1. A resist pattern prediction device comprising:
an optical proximity correction module configured to generate an aerial image by performing an optical proximity correction based on a mask image, and to generate a resist image by performing a non-optical proximity correction on the mask image and the aerial image; and
a pattern prediction module configured to predict information with respect to a resist pattern based on the resist image, and
wherein performing the non-optical proximity correction includes performing a convolution operation on the aerial image using a Volterra kernel based on a coefficient of a quadratic term of a Volterra series.

2. The resist pattern prediction device of claim 1, wherein an optical proximity correction module includes:
an optical model configured to perform the optical proximity correction based on the mask image to generate the aerial image; and
a resist model configured to generate the resist image by performing the non-optical proximity correction on the mask image and the aerial image, and
wherein the resist model is configured to perform the non-optical proximity correction by applying an acid-quencher mutual diffusion model (AQDM).

3. The resist pattern prediction device of claim 2, wherein the optical proximity correction module is configured to:
generate a convolution mask image by performing a convolution operation using a first kernel on the mask image;
generate a convolution aerial image by performing a convolution operation using a second kernel on the aerial image;
generate a quenching aerial image by performing a quenching operation on the aerial image;
generate a Volterra aerial image by performing a Volterra operation based on the quadratic term of the Volterra series on the aerial image; and
generate the resist image by summing the convolution mask image, the convolution aerial image, the quenching aerial image, and the Volterra aerial image.

4. The resist pattern prediction device of claim 3, wherein the first kernel and the second kernel are free-form kernels.

5. The resist pattern prediction device of claim 3, wherein the optical proximity correction unit is configured to:
generate a first acid aerial image and a first base aerial image based on the aerial image;
generate a second acid aerial image and a second base aerial image based on the aerial image;
generate a convolutional first acid aerial image by performing a convolution operation using a third kernel on the first acid aerial image;
generate a convolution first base aerial image by performing a convolution operation using a fourth kernel on the first base aerial image;
generate a convolution second acid aerial image by performing a convolution operation using a fifth kernel on the second acid aerial image;
generate a convolution second base aerial image by performing a convolution operation using a sixth kernel on the second base aerial image; and
sum the convolution first acid aerial image, the convolution first base aerial image, the convolution second acid aerial image, and the convolution second base aerial image to generate the quenching aerial image.

6. The resist pattern prediction device of claim 5, wherein the optical proximity correction module is configured to generate the first acid aerial image by performing a base truncation operation based on a first reference value, and to generate the first base aerial image by performing an acid truncation operation based on the first reference value, and
wherein optical proximity correction module is configured to generate the second acid aerial image by performing a base truncation operation based on a second reference value, and to generate the second base aerial image by performing an acid truncation operation based on the second reference value.

7. The resist pattern prediction device of claim 3, wherein the optical proximity correction unit is configured to:
generate a first Volterra convolution aerial image using a first Volterra kernel with respect to the aerial image;
generate a second Volterra convolution aerial image using a second Volterra kernel with respect to the aerial image;
generate a third Volterra convolution aerial image using a third Volterra kernel with respect to the aerial image;
generate a fourth Volterra convolution aerial image using a fourth Volterra kernel with respect to the aerial image;
perform a matrix multiplication operation on the first Volterra convolution aerial image and the second Volterra convolution aerial image to generate a first multiplication aerial image;
perform the matrix multiplication operation on the third Volterra convolution aerial image and the fourth Volterra convolution aerial image to generate a second multiplication aerial image; and
generate the Volterra aerial image by summing the first multiplication aerial image and the second multiplication aerial image.

8. The resist pattern prediction device of claim 7, wherein the first to fourth Volterra kernels are defined on a coordinate plane defined by a first axis and a second axis,
wherein the first Volterra kernel includes a plurality of first Volterra kernel data as in:
VK_{D1}=σₙ(r)cos nθ
wherein the second Volterra kernel includes a plurality of second Volterra kernel data as in:
VK_{D2}=τₙ(r)cos nθ
wherein the third Volterra kernel includes a plurality of third Volterra kernel data as in:
VK_{D3}=σₙ(r)sin nθ
wherein the fourth Volterra kernel includes a plurality of fourth Volterra kernel data as in:
VK_D4=τₙ(r)sin nθ
where ‘r’ means a distance of coordinates of the first Volterra kernel data from an origin of the coordinate plane, θ means an angle counterclockwise from the first axis, σₙ(r) means a first coefficient of the quadratic term of the Volterra series with the distance ‘r’ as a variable, τₙ(r) means a second coefficient of the quadratic term of the Volterra series with the distance ‘r’ as a variable, and ‘n’ is an integer greater than or equal to 1.

9. The resist pattern prediction device of claim 1, wherein the pattern prediction module is configured to extract edge placement coordinates based on the resist image and to predict the resist pattern based on the edge placement coordinates.

10. The resist pattern prediction device of claim 9, wherein the resist image includes a plurality of pixels to which resist image data is assigned, and
wherein the pattern prediction module is configured to extract the edge placement coordinates based on an amount of change in the resist image data.

11. The resist pattern prediction device of claim 9, wherein the resist image includes a plurality of pixels to which resist image data is assigned, and
wherein the pattern prediction module is configured to extract the edge placement coordinates by comparing the resist image data with a threshold value.

12. The resist pattern prediction device of claim 9, wherein the pattern prediction module is configured to predict a pattern shape by connecting adjacent edge placement coordinates and by extracting a contour of the resist pattern.

13. A semiconductor layout design system comprising:
a layout design device configured to generate an initial mask image for fabricating a photomask;
a resist pattern prediction device configured to generate prediction data including information on a resist pattern, the resist pattern being formed on a wafer based on the initial mask image, and
wherein the layout design device is configured to generate a final layout with respect to the initial mask image based on the prediction data, and
wherein the resist pattern prediction device is configured to:
generate an aerial image by performing an optical proximity correction based on the initial mask image;
generate a resist image by performing a non-optical proximity correction on the initial mask image and the aerial image; and
predict information with respect to the resist pattern based on the resist image to generate the prediction data, and
wherein performing the non-optical proximity correction includes performing a convolution operation on the aerial image using a Volterra kernel based on a coefficient of a quadratic term of a Volterra series.

14. The semiconductor layout design system of claim 13, wherein the optical proximity correction is performed based on an optical element capable of changing an intensity and shape of light until the light passing through the photomask reaches a resist film on the wafer during an exposure process, and
wherein the resist image generated by the non-optical proximity correction is an image to reflect a degree to which a resist film is reacted during the exposure process.

15. The semiconductor layout design system of claim 13, wherein the layout design device is configured to set a target resist pattern and compare the target resist pattern with the prediction data generated by the resist pattern prediction device to generate a final layout.

16. A system for constructing a resist pattern prediction device, the system comprising:
a database configured to store a sample mask image and gauge data obtained by gauging an actual resist pattern generated using a photomask created based on the sample mask image;
an optical proximity correction module configured to generate a sample resist image through a convolution operation using a kernel based on the sample mask image;
a pattern prediction module configured to predict information with respect to a resist pattern based on the sample resist image to generate prediction data; and
an optimization module configured to update parameters of the kernel of the optical proximity correction module by performing an optimization operation based on the gauge data and the prediction data, and
wherein the gauge data includes information associated with gauge edge placement coordinates and gauge critical dimensions, and
wherein the prediction data includes information associated with predicted edge placement coordinates and predicted critical dimensions.

17. The system of claim 16, wherein the optimization module is configured to:
calculate a critical dimension error based on the predicted critical dimensions and the gauge critical dimensions;
calculate an edge placement error based on the predicted edge placement coordinates and the gauge edge placement coordinates; and
update the parameters based on the critical dimension error and the edge placement error.

18. The system of claim 17, wherein the optimization module is configured to calculate the edge placement error based on a distance between the predicted edge placement coordinates and the gauge edge placement coordinates.

19. The system of claim 17, wherein the optimization module is configured to calculate the edge placement error based on resist image data of the sample resist image and the gauge edge placement coordinates.

20. The system of claim 17, wherein the optimization module is configured to update the parameters using an optimization algorithm of a convolutional neural network by setting the critical dimension error and the edge placement error as a loss function.
